(19) United States
(12) Patent Application Publication
(10) Pub. No.: US 2012/0322596 A1
(43) Pub. Date: Dec. 20, 2012

(54) CHAIN TENSIONING DEVICE FOR USE IN A MOTOR VEHICLE

(75) Inventors: Dominik Hofmann, Bamberg (DE); Christian Hartmann, Nemsdorf (DE); Sven Strassberger, Stuttgart (DE); Torge Lassen, Gross-Niendorf (DE); Peter Holstein, Sussen (DE); Willy Treyz, Neckartailfingen (DE)

(73) Assignee: SCHAEFFLER TECHNOLOGIES AG & CO. KG, Herzogenaurach (DE)

(21) Appl. No.: 13/525,625

(22) Filed: Jun. 18, 2012

(30) Foreign Application Priority Data
Jun. 16, 2011 (DE) 102011104420.9

(51) Int. Cl. F16H 7/08

(52) U.S. Cl. 474/110

(57) ABSTRACT

A chain tensioning device for use in a motor vehicle with a cylinder-piston unit (10) that has a piston housing (11) and a tensioning piston (12) that is provided for tensioning a chain and is arranged at least partially in the piston housing (11). A chain tensioner housing (13) is provided for establishing a flow connection between the cylinder-piston unit (10) and an operating medium circuit and holds at least partially the cylinder-piston unit (10). A compression joint fixes the piston housing (11) and the chain tensioner housing (13) against each other at least in the axial direction. The compression joint is constructed as a press fit by which the piston housing (11) and the chain tensioner housing (13) are directly connected to each other with a friction fit.

### CROSS-REFERENCE TO RELATED APPLICATIONS

This application claims the benefit of German Patent Application No. 102011104420.9, filed Jun. 16, 2011, which is incorporated herein by reference as if fully set forth.

### BACKGROUND

The present invention relates to a chain tensioning device.

From DE 10 2007 036 119 A1, a chain tensioning device for use in a motor vehicle is already known, with a cylinder-piston unit that has a piston housing and a tensioning piston that is provided for tensioning a chain and is arranged at least partially in the piston housing, with a chain tensioner housing that is provided for establishing a flow connection between the cylinder-piston unit and an operating medium circuit and partially holds the cylinder-piston unit, and with a compression joint that fixes the piston housing and the chain tensioner housing against each other in the axial direction.

### SUMMARY

The invention is based on the objective of providing an economical chain tensioning device that features high functional stability. This task is achieved according to the invention. Various embodiments and features of the invention are described below and in the claims.

The invention starts with a chain tensioning device for use in a motor vehicle with a cylinder-piston unit that has a piston housing and a tensioning piston that is provided for tensioning a chain and is arranged at least partially in the piston housing, with a chain tensioner housing that is provided for establishing a flow connection between the cylinder-piston unit and an operating medium circuit and at least partially holds the cylinder-piston unit, and with a compression joint that fixes the piston housing and the chain tensioner housing against each other at least in the axial direction.

The compression joint is here constructed as a press fit by which the piston housing and the chain tensioner housing are directly connected to each other with a friction fit. In this way, an axial fixing of the piston housing in the chain tensioner housing can be realized in an especially simple way, wherein an axial displacement of the piston housing and thus the cylinder-piston unit in the chain tensioner housing can be prevented, for example, due to a high operating medium pressure. In particular, a temporary cancelation of a hydraulic function of the cylinder-piston unit can be prevented and a design-compatible hydraulic function can be guaranteed, wherein excess loads and unnecessary joint movements can be prevented. Therefore a functional stability of the chain tensioning device can be increased, wherein wear can be reduced. Through the friction-fit direct connection, a press fit connection can be realized without an additional jamming and/or pressing element between the piston housing and the chain tensioner housing, wherein the costs and/or weight of the chain tensioning device can be reduced. Thus a very economical chain tensioning device can be provided that has high functional stability. A “tensioning piston” should be understood to be, in particular, a piston that is arranged in the piston housing so that it can move in the axial direction and contacts the chain indirectly or directly and is provided for applying a tensioning force on the chain. A “tensioning piston that is arranged at least partially in the piston housing” should be understood to be, in particular, a tensioning piston that is held and/or surrounded at least partially by the piston housing. “Held at least partially” should be understood to be, in particular, enclosing at least in one sub-region. “Axial” should be understood to be, in particular, along a longitudinal axis and/or a formation direction of a recess of the chain tensioner housing in which the cylinder-piston unit is arranged. A “press fit” should be understood to be, in particular, a tight fit and/or an interference fit of the piston housing and the chain tensioner housing relative to each other. A “friction-fit direct connection” should be understood to be, in particular, a connection produced by a force generated by a direct and thus tight contact of the piston housing and the chain tensioner housing, i.e., without a jamming and/or pressing element arranged in-between and/or provided for this purpose.

It is further proposed that the chain tensioner housing has a recess with an inner diameter that is smaller than an outer diameter of the piston housing at least in one region. Therefore, a compression joint without a jamming and/or pressing element can be realized in an especially simple way.

It is also proposed that the compression joint constructed as a press fit is sealed relative to the pressurized medium in a normal operating temperature range. Therefore, an operating medium reservoir of the chain tensioning device can be prevented from running empty, wherein negative acoustic and/or dynamic effects can be prevented in a starting process and the hydraulic function can also be guaranteed in a starting process. An “operating medium reservoir of the chain tensioning device” should be understood to be, in particular, a structural operating medium reservoir that is provided for supplying operating medium to the cylinder-piston unit during the starting process and thus, in particular, starting from a low operating medium pressure in the operating medium circuit. A “starting process” should be understood to be, in particular, a motor startup process of an internal combustion engine of the motor vehicle with the chain tensioning device. A “normal operating temperature range” should be understood to be, in particular, a temperature range of the chain tensioning device that is to be expected during normal operation of the motor vehicle and for which the compression joint constructed as a press fit is designed advantageously under consideration of a temperature-dependent change in diameter of the piston housing and the chain tensioner housing. Advantageously the normal operating temperature range lies between −80 degrees Celsius and +200 degrees Celsius and in an especially advantageous way between −40 degrees Celsius and +150 degrees Celsius. A “consideration of a temperature-dependent change in diameter of the piston housing and the chain tensioner housing” should be understood such that, in particular, for the design of the compression joint as a press fit, the different temperature expansion coefficients of the piston housing and the chain tensioner housing resulting due to different materials of the piston housing and the chain tensioner housing were taken into consideration. Naturally the piston housing and the chain tensioner housing could be constructed from the same materials, wherein the consideration of the temperature expansion coefficients could be eliminated.

### BRIEF DESCRIPTION OF THE DRAWINGS

Additional advantages can be found in the following description of the drawing. In the drawing, an embodiment of the invention is shown. The drawing, the description, and the claims contain numerous features in combination. Someone skilled in the art will also consider the features individually and combine them into meaningful additional combinations.

### DETAILED DESCRIPTION OF THE PREFERRED EMBODIMENT

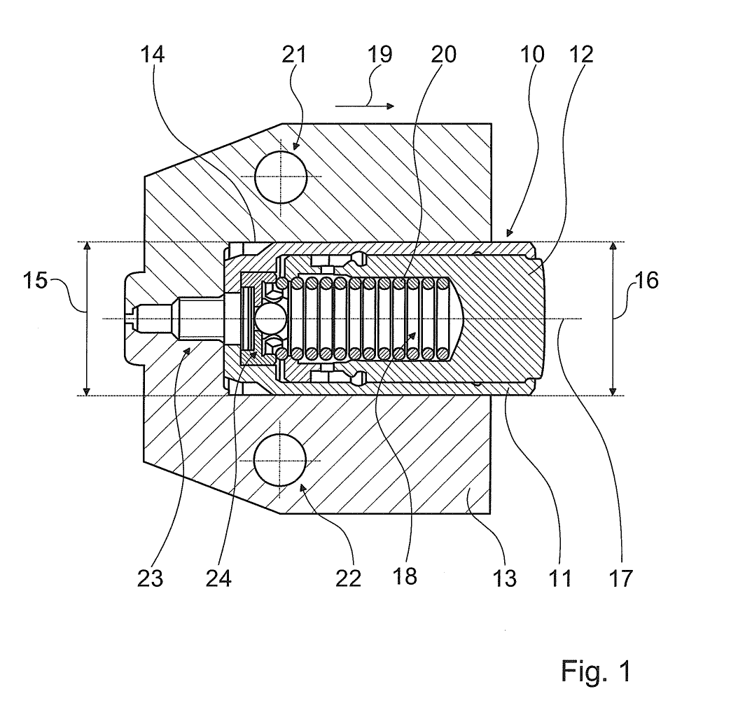

FIG. 1 shows a chain tensioning device that is constructed as an example and is provided for use in a motor vehicle. The chain tensioning device is constructed as a hydraulic chain tensioning device. In this embodiment, the chain tensioning device is provided for an internal combustion engine of the motor vehicle. The chain tensioning device is allocated to a chain drive of a camshaft of the internal combustion engine of the motor vehicle. It is provided for tensioning a chain of the chain drive connecting a crankshaft and the camshaft in a torque-transmitting manner. In principle, the chain tensioning device could also be provided for an auxiliary assembly, such as for a pump.

For realizing a variable tensioning force acting on the chain, the chain tensioning device has a cylinder-piston unit 10. The cylinder-piston unit 10 has a piston housing 11 and a tensioning piston 12 that is provided for tensioning the chain and is inserted in the piston housing 11. The tensioning piston 12 is arranged so that it can move partially in the axial direction in the piston housing 11. It is arranged in the piston housing 11 so that it can move partially along a longitudinal axis 17 of the chain tensioning device. The piston housing 11 partially holds the tensioning piston 12. The tensioning piston 12 that can move back and forth is provided for contacting and thus tensioning the chain indirectly by a tensioning rail. It provides the tensioning force acting on the chain.

For providing the variable tensioning force, the piston housing 11 and the tensioning piston 12 together form a hydraulic pressure chamber 18. By pressurizing the pressure chamber 18 with an operating medium, a hydraulic force is generated that moves the tensioning piston 12 axially in a tensioning direction 19. The operating medium is realized as an oil.

For providing a mechanical pre-tensioning force, the cylinder-piston unit 10 has a compression spring 20 that is arranged in the piston housing 11. The compression spring 20 is arranged in the pressure chamber 18. The compression spring 20 is arranged effectively between the piston housing 11 and the tensioning piston 12. The compression spring 20 is constructed as a helical spring.

For a fixed connection to a motor housing, in particular, to a cylinder head, of the internal combustion engine and for establishing a flow connection between the cylinder-piston unit 10 and an operating medium circuit of the internal combustion engine, the chain tensioning device has a chain tensioner housing 13 that partially holds the cylinder-piston unit 10. For partially holding the cylinder-piston unit 10, the chain tensioner housing 13 has a recess 14. The cylinder-piston unit 10 is arranged partially in the recess 14. The piston housing 11 of the cylinder-piston unit 10 is supported on the chain tensioner housing 13. The chain tensioner housing 13 is supported on the motor housing.

The chain tensioner housing 13 is provided for establishing a flow connection between the pressure chamber 18 of the cylinder-piston unit 10 and the operating medium circuit of the internal combustion engine. For the fixed connection to the motor housing, it has two positive-fit connection points 21, 22. The chain tensioner housing 13 is screwed to the motor housing at the connection points 21, 22. For establishing the flow connection to the operating medium circuit, the chain tensioner housing 13 has an operating medium guide 23. The operating medium guide 23 establishes flow connection between the pressure chamber 18 and the operating medium circuit of the internal combustion engine.

The chain tensioning device furthermore has a compression joint that fixes the piston housing 11 and the chain tensioner housing 13 against each other in the axial direction. The piston housing 11 and the chain tensioner housing 13 are connected to each other with a friction fit at the compression joint. For the direct friction-fit connection of the piston housing 11 to the chain tensioner housing 13, the compression joint is constructed as a press fit. The piston housing 11 and the chain tensioner housing 13 are directly connected to each other with a friction fit by the press fit. They are pressed into each other directly in a jamming and pressing element-free way and thus without a jamming and pressing element. The piston housing 11 of the cylinder-piston unit 10 is directly pressed in the chain tensioner housing 13. It is pressed directly into the recess 14.

For realizing the compression joint constructed as a press fit, the recess 14 of the chain tensioner housing 13 has an inner diameter 15 that is smaller than an outer diameter 16 of the piston housing 11. The compression joint constructed as a press fit is thus produced by a direct and thus tight pressing of the chain tensioner housing 13 against the piston housing 11.

The compression joint constructed as a press fit is sealed against compressed medium. It avoids a ring gap between the chain tensioner housing 13 and the piston housing 11. The chain tensioner housing 13 and the piston housing 11 contact each other directly due to the press fit. The compression joint constructed as a press fit avoids operating medium leaks between the chain tensioner housing 13 and the piston housing 11, wherein running empty is prevented in an overhead position of the cylinder-piston unit 10, i.e., in a position in which the tensioning direction 19 points at least partially in the direction of a base on which the motor vehicle is standing. In principle, the compression joint constructed as a press fit can be designed so that it is sealed against compressed medium only in a normal operating temperature range. The normal operating temperature range is between −40 and +150 degrees Celsius.

In addition, the cylinder-piston unit 10 has a non-return valve 24 that is provided for establishing a flow connection between the pressure chamber 18 and the operating medium guide 23 in an operating state and for separating them in another operating state. The non-return valve 24 has a passage direction and a blocking direction. The passage direction points in the direction of the pressure chamber 18 starting from the operating medium guide 23, and the blocking direction points in the direction of the operating medium guide 23 starting from the pressure chamber 18.

1. A chain tensioning device for use in a motor vehicle, comprising a cylinder-piston unit that has a piston housing and a tensioning piston that is provided for tensioning a chain and is arranged at least partially in the piston housing, with a chain tensioner housing that is provided for establishing a flow connection between the cylinder-piston unit and an operating medium circuit and holds the cylinder-piston unit at least partially, and a compression joint fixes the piston housing and the chain tensioner housing against each other at least in the axial direction, wherein the compression joint is constructed as a press fit by which the piston housing and the chain tensioner housing are connected directly to each other with a friction fit.

2. The chain tensioning device according to claim 1, wherein the chain tensioner housing has a recess with an inner diameter that is smaller than an outer diameter of the piston housing at least in one region.

3. The chain tensioning device according to claim 1, wherein the compression joint constructed as a press fit is sealed relative to pressurized medium at least in a normal operating temperature range.
